(19) United States
(12) Patent Application Publication
(10) Pub. No.: US 2016/0010276 A1
(43) Pub. Date: Jan. 14, 2016

(54) Arylene Carriers for Enhanced Polycarbonate Tinting

(71) Applicant: ESSILOR INTERNATIONAL (COMPAGNIE GÉNÉRALE D'OPTIQUE), Charenton Le Pont (FR)

(72) Inventor: Prakhar KASTURE, Singapore (SG)

(73) Assignee: ESSILOR INTERNATIONAL (COMPAGNIE GENERALE D'OPTIQUE), Charenton Le Pont (FR)

(21) Appl. No.: 14/773,180

(22) PCT Filed: Mar. 6, 2014
(86) PCT No.: PCT/EP2014/054385

§ 371 Date: Sep. 4, 2015

(30) Foreign Application Priority Data
Mar. 6, 2013 (EP) 13305252.2

(51) Int. Cl. D06P 1/651; D06P 1/16; G02B 1/04; D06P 3/54

(52) U.S. Cl. CPC D06P 1/65187; D06P 3/54; D06P 1/16; G02B 1/043

(57) ABSTRACT

The invention pertains to a tinting composition for tinting objects made of polymeric material comprising a dye, solvent and some carrier compound for enhancing dye penetration into the polymeric material wherein the compound is one of a group enclosing at least 4-(methyl thio) benzyl alcohol, 4,4′ thiodiphenol, and 4,4′ thio bis benzenethiol: formulae (I); (II); (III).

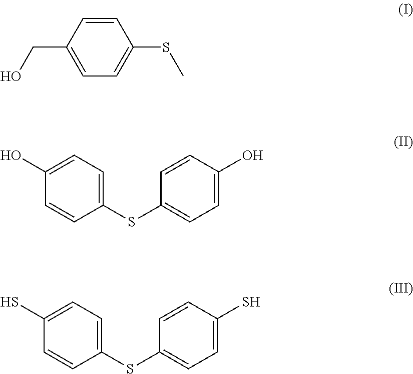

The present invention pertains to a method for dyeing substrates to obtain tinted substrates or articles, for example tinted optical or ophthalmic lenses. The invention particularly concerns articles obtained from substrates comprising polycarbonate (PC). In particular the invention pertains to the problem of tinting polycarbonate lenses for the ophthalmic industry, considering the high transparency, low haze and mechanical properties necessary in this optical field.

Ophthalmic lenses of transparent organic material (organic glass) are lighter and less brittle than mineral glass and are now widely used. One of the polymer used as organic glass for ophthalmic lenses is Polycarbonate. Indeed, it is a polymer widely used to make plastic solids due to its high resistance to breakage compared to its weight. Further, it has the advantage of existing in low-haze, high transparency compositions and it is relatively cheap to manufacture as it is a thermoplastic material.

However, substrates of polycarbonate material are difficult to tint with conventional processes such as conventional direct bath tinting due to its compact surface morphology and high glass temperature. Water bath tinting is usually not suitable because of its limited dye absorption amount, even during prolonged time. It is thus difficult for the ophthalmic industry to produce polycarbonate-based lenses which have a tinting with the quality necessary for ophthalmic grades-lenses.

Some known techniques are to deposit a tintable or tinted hard-coat layer on top of the polycarbonate substrate. However, not only many of the prior art tintable hard-coatings are however still lacking abrasion resistance when compared to mineral glass, but such step requires an additional layer which may increase production costs.

Further, some techniques have proposed using organic solvents in the dye solution or employing pretreatment such as UV irradiation before tinting. Use of organic solvent makes the tinting process environmentally hazardous and an UV pretreatment requires additional process time and infrastructure.

Further, EP2319981 proposes using additional thiol carriers in the tinting bath. However the tinting baths produced using such sulfur-containing carriers might in some case produce smelly and sometimes pungent emanations.

Therefore there is a need for a process for tinting substrates of polycarbonate lenses, overcoming the limitations of the known processes, without compromising the tinting homogeneity. Advantageously the present invention discloses a method that addresses the issues discussed above.

The invention provides a solution for tinting substrates of polycarbonate in a short time and achieving a higher tinting intensity with good uniformity. These and other advantages are achieved in accordance with the present invention as described below.

The invention discloses a tinting composition comprising at least one dye, or dye precursor, and at least one carrier in at least one solvent, the carrier being chosen from the compounds represented by the following formulae (1):

[AL1-Sp2-Ar-Sp1]_{2-y}-X-Ak_{y} (1)

with

X representing O or S,

Sp1 and Sp2 being identical or different and representing one of a chemical bound or a spacer composed by a (C1-C2) alkylene group, linear or branched,

Ar representing one of a (C5-C12) arylene group and a (C5-C12) heteroarylene group,

AL1 representing one of a —SH or a —OH radical or one of a —O—CH2-OH, —S—CH2-OH, —O—CH2-SH, —S—CH2-SH group,

Ak representing a (C1-C6) alkyl group, linear or branched, with 0 to 2 non-consecutive non terminal carbons replaced by O or S,

y being 0 or 1, and when y=0, the two AL1-Sp2-Ar-Sp1- branches can be identical or different.

In some embodiments, with y=0, the two AL1-Sp2-Ar-Sp1- branches are identical.

In some embodiments, all Sp1, Sp2 and Ak, if present, taken together do not contribute to the structure with more than four, preferentially two atoms of the group consisting of C, S, O.

The Ar group may be a phenylene group or a toluylene group.

Without being bound by theory, the carriers are thought to cause some swelling of the fiber. It seems that they can enter into the fine structure of the polycarbonate and push adjacent long-chain molecules apart. This loosens up the molecular pattern and facilitates the entry of the large dyestuff molecules and seems to act as opening pores into the surface of the polycarbonate. However it is also thought that the carrier does not react with the polycarbonate matrix after opening the surface of the polycarbonate to the dyes. Indeed, after immersion of the substrate into the composition and after a step of rinsing it was observed, by monitoring the carrier concentration in the tinting bath after more than 30 tinting processes, that very little of the carrier compound is trapped into the polycarbonate. Carrier concentration was measured using mass spectroscopy.

When the solvent is water the water insoluble carriers often appear to from a surface film on the fiber in which the disperse dye is highly soluble. The transfer of dye, in such circumstances, does not take place between the aqueous phase and the fiber but between dyestuff dissolved in the carrier and fiber.

The composition contains from 0.05% to 2% included of carrier, preferably from 0.2% to 1%, for example 0.5%. This optimum carrier concentration corresponds approximately with the amount necessary to saturate both fiber and dye bath phase of the system. Excess will introduce a third phase, namely undisclosed carrier, which will compete with the fiber for the dye.

The composition contains from 0.1% to 2% included of dye, preferably from 0.5% to 1%.

The dye may be any known dye or tinting agent.

The composition contains from 0.1% to 5% of surfactant, preferably from 0.5% to 2%.

The innovation is also related to a method for dyeing a substrate of polycarbonate, said method comprising the following successive steps:
a supply of a tinting composition according to the invention:
an exposure of at least a part of one of the substrate's surfaces to the tinting composition of the invention for a time sufficient to allow the effective tinting of the substrate.

In some embodiment there are optional steps of rinsing the substrate to remove excess dye and of curing the substrate in order to fix the dye molecules deep into the substrate. Without being bound by theory, it is thought that the curing step only help imbibing of dye molecules which move from the surface toward deeper inside the substrate.

According to the invention, the exposure step can be done by spin-coating the tinting composition on top of at least part of the substrate.

Alternatively, the exposure step can be done by immersion of at least part of the substrate in a bath of the tinting composition, this type of exposure step is generally known by the word “dip” or “dipping”.

The exposure step may be carried out once, or can be repeated several times, in order to manufacture a tinted substrate of higher intensity. This step can be carried out by the use of a dyeing apparatus, in which the substrate is contacted with the dye solution according to scheduled sequences.

The substrate can be exposed to the tinting composition totally, or partially. If the substrate is immersed partially, generally only the surface of the immersed part of the substrate is tinted.

The substrate can combine multiple exposure steps, at least two exposure steps covering different areas of the substrate, one area exposed to the tinting composition during one exposure step being at least partially included in another exposed to the tinting composition during one exposure step without totally covering it. Thus it enables to create gradient-like tinting.

The substrate can be a commercially available product, or it can be manufactured just before the tinting.

The substrate has generally the shape of an article, such as an optical article or even an ophthalmic article.

The method according to the invention is rapid, reproducible and easy to carry out. Moreover the tinting of the part of the substrate which is immersed is substantially uniform.

In addition, this method allows the production of the whole range of coloration, from the lightest colour to the darkest colour.

A substrate, in the sense of the present invention, should be understood to mean an uncoated substrate. The substrate may in particular be an optically transparent material having the shape of an optical article, for example an ophthalmic lens destined to be mounted in glasses.

In particular, some polycarbonate substrate lenses are provided with a coating designed to protect the surface of the polycarbonate during shipment. In such case the invention relates more particularly to such lenses which have been submitted to a stripping step, adapted to remove the protection coating so that the tinting composition can be put in direct contact with the polycarbonate material itself.

In a preferred manner the carrier is chosen from the following group of compounds (o,m,p)Methoxyphenol, (o,m,p)Methoxythiophenol, (o,p)(Methylthio)thiophenol, (o,m,p)(Methylthio) phenol, (o,m,p)methoxy benzyl alcohol, (m,p)methoxy benzyl thiol, (o,p)(methyl thio) benzyl alcohol, 2,2′oxydiphenol, 4,4′oxydiphenol, 2,2′thiodiphenol, 4,4′thiodiphenol, 2,2′-oxybisbenzenethiol, 4,4′-oxybisbenzenethiol, 4,4′-thiobisbenzenethiol.

The carrier may also be one of the variants of the previous compounds for which at least one phenylen group is substituted with a methyl group or a methylen group between the phenylene and the hydroxyl or thiol group or between the phenylene and the oxy or thio bivalent groups, such as 2,2′-thiobis[4-methyl-Phenol] and 4,4′-thiobis[2-methyl-Phenol], 2-Methoxy-4-methylphenol, 4-Methoxy-2-methylphenol, 2-Methoxy-3 -methylphenol, 3-Methoxy-2-methylphenol, 2-Methoxy-4-methylbenzyl alcohol, 4-Methoxy-2-methylbenzyl alcohol, 4-Methoxy-3-methylbenzyl alcohol, 2,2′-Dimethyl-4,4′-thiodiphenol, 4,4′, thiobis[2-methylbenzene thiol] . . . etc.

More preferably the carrier is chosen from the group consisting of 4-(methyl thio) benzyl alcohol, 4,4′ thiodiphenol or 4,4′ thio bis benzenethiol, illustrated bellow, respectively in formulas 2, 3 and 4:

Formula 2: 4-(methyl thio) benzyl alcohol (CAS 3446-90-0)

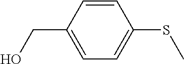

Formula 3: 4,4′ thiodiphenol (CAS 2664-63-3)

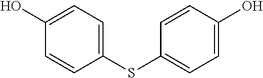 [SMILES: Oc1ccc(Sc2ccc(O)cc2)cc1]

Formula 4: 4,4′ thio bis benzenethiol (CAS 19362-77-7)

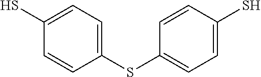 [SMILES: Sc1ccc(Sc2ccc(S)cc2)cc1]

Most preferred carrier compound is 4,4′ thiodiphenol.

Preferably, the solvent is water or an organic solvent, and more preferably the solvent is water.

According to the invention, the dye solution can contain a dye of any dye type and particularly can be chosen from the group of azo type dyes, quinophtalones type dyes, and anthraquinone type dyes. It can be any commercial disperse dye sold by BASF, Clariant, Huntsman or any other provider of known disperse dyes.

However various known dyes mixture or dyes solutions used in dyeing can be used, as known to the one skilled in the art.

The dye solutions which are suitable are commercially available disperse dye solutions, to be combined with at least one carrier according to the invention. For example, the dyes sold as BPI® Molecular Catalytic Tints by Brain Power International are available in more than 180 colours. The disperse dyes produced by Ciba, BASF, Dyestar, Clariants etc. are also useable for PC tinting.

In a variant, the dye solution contains 0.05% to 5%, preferably 0.2% to 1%, and more preferably around 0.5% by weight of the carrier.

The amount of the dye is not critical but is ordinarily 0.1 to 30% by weight in terms of concentration in the tinting composition, for example 0.5% or 0.75%.

The dye solution can comprise any other additive known to the one skilled in the art. According to the invention, the dye solution can contain an emulsifier, preferably chosen from the group of amine salts or alkali salts of carboxylic, sulfamic or phosphoric acids, acid salts of amines, ethoxylated or propoxylated alkyl or aryl phenolic compounds.

A surfactant, such as alkyl benzene sulfonate might be present in the tinting composition with a concentration ranging from 0% to 5% in weight included, preferably with a concentration ranging from 0.1% to 3% by weight included, more preferably with a concentration ranging from 0.2% to 2% by weight included.

Other surfactant which may be used include ionic, non-ionic, or mixtures thereof. Exemplary surfactant might be anionic, including sodium and potassium dinaphtalene meta sulphonate, sodium salt of dodecyl benzene sulphonic acid (DDBSA), Lauryl ether sulphate sodium salt or potassium lauryl sulphate. Other surfactant may also be used if necessary, such as amphoteric surfactants, that is compounds bearing both anionic and cationic groups.

The method of the invention provides tinted substrates in a short time and achieves a higher tinting intensity with good uniformity.

The method of the invention enables tinting substrates to be provided of different luminous transmittance depending mainly on different tinting times and dye solutions of different dye concentration.

Preferably, the exposure of the substrate to the tinting composition has a duration that is within the range of from 3 to 100 minutes, preferably from 5 to 60 minutes, and more preferably from 10 to 40 minutes, such as 20 or 30 minutes.

According to the invention, the method can further comprise the heating of the tinting composition, at least during the exposure step, at a temperature of from 90 to 100° C., preferably from 90 to 96° C., and more preferably from 93 to 96° C., for example 94° C. or 95° C. In the case of an exposure by immersion of the substrate, the tinting composition might already be at the above mentioned temperature when starting the immersion.

The invention also concerns an article, preferably an ophthalmic lens, comprising a tinted substrate which is obtained by the method described above.

According to the invention, the article is preferably such that the luminous transmittance of the article is lower than 20%, preferably lower than 15%, and more preferably lower than 10%.

According to the invention, the article is preferably such that the haze of the article is lower than 5%, preferably lower than 1%, and more preferably lower than 0.4%. Said article may advantageously be coated, after the tinting step, with coatings conventionally used in the ophthalmic optics field, such as anti abrasion coatings, scratch resistant coatings or anti-reflection coatings.

The invention thus also concerns said article further comprising at least partially a coating.

### DEFINITIONS

Alkylene groups represent bivalent groups derived from alkanes by removal of two hydrogen atoms. The removed hydrogen atoms may be removed either from one given carbon atom or from two different carbon atoms. A synonym is alkanediyl groups. The alkylene groups in the context of the invention may be linear or branched alkylenes.

Preferable alkylene groups are chosen between no alkylene group and methanediyl (a divalent alkane derived from methane —CH2-). An alkylene group in the context of the invention involves the presence of carbon atoms at every end: on the atoms from which the two hydrogen atoms cited above are removed and at the end of any branch in case of a branched alkylene.

Arylene groups represent bivalent groups derived from aryl groups by removal of a further hydrogen atom from a further ring carbon atom. A synonym is arenediyl groups. It represent in particular any monocyclic or polycyclic hydrocarbon group comprising at least one aromatic cycle wherein all ring-atoms are carbon, from which two hydrogen have been removed to create a divalent group.

The arylene groups in the context of the invention may have some ring-atoms substituted with linear or branched alkyl groups or alkoxy groups, or alkylthio groups or halogen atoms where it does not modify the valence of the substituted atom. In any case, the two hydrogen's atoms presented above are removed from a ring-carbon of one of the cycles and not of any of the possible substituted groups.

In the context of the invention, preferable arylene groups are (o,m,p)phenylene, 1,2 naphtylene, 1,5 naphthylene, 1,7 naphthylene, 1,8 naphthylene, toluylene, also known as 2-methyl-phenylene, 3-methyl-phenylene, or 4-methyl-phenylene.

Heteroarylene groups represent bivalent groups derived from heteroaryl groups. The heteroarylene groups in the context of the invention may have some ring-atoms substituted with linear or branched alkyl groups or alkoxy groups, or alkylthio groups or halogen atoms where it does not modify the valence of the substituted atom. In any case, the two hydrogen's atoms presented above are removed from a ring-atom of one of the cycles and not of any of the possible substituted groups.

### FIGURES

FIG. 1: Flow chart illustrating one embodiment of a process for preparing the composition of the invention.

FIG. 2: Flow-chart illustrating one embodiment of the process of the invention.

The invention will be further illustrated by the following non-limiting examples which are given for illustrative purposes only.

### EXAMPLES

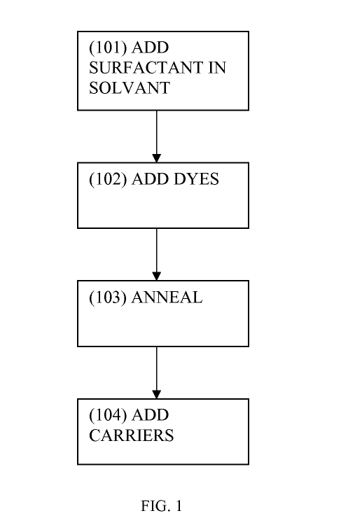

Preparation of the tinting compositions, illustrated by FIG. 1:

In the following examples the carriers were incorporated in a typical tinting composition, formulated by addition 0.5-2% of surfactant in water, in step (101), followed by 0.5-1% of dyes at temperature of 50-80° C., in step (102), and maintained at 80-95° C. from 2 hours to 3 hours long, in step (103), in order to get a stable tinting composition with good dispersion of dyes. In a further step (104), 0.2-1% of carrier is then added and maintained at 80-95° C. for about from 20 min to 40 min.

In particular, in the following examples, the tinting compositions comprise water as solvent, and a dye solution made of Ciba Teratop dyes: Teratop NFR (Red), Teratop NFG (Yellow) and Teratop NFB (Blue). These dyes are mixed in order to obtain a grey/green shade with less than 10% of Teratop NFR, between 45% and 55% of Teratop NFG and the remaining being Teratop NFB.

In the examples the dyes were present at 0.75% in weight.

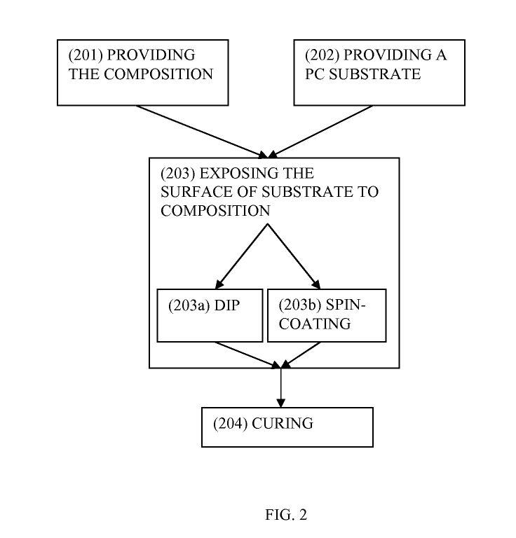

General tinting process, illustrated by FIG. 2:

Thereafter the exposure step was done by immersing, in step (203), a PC substrate (provided in step (202)) into a bath of the tinting composition, provided in step (201), for a duration comprised between 10 minutes and 60 minutes with a bath temperature of roughly 95° C., both faces of the substrate being exposed to the tinting composition.

Thereafter, the substrates are rinsed and cured (in step (204)), rinsing may be done using tape water or deionized water. The curing may last, in the examples, for two hours at 135° C. to imbibe the dye into the substrate completely.

According to the invention the exposure step (203) can be done by immersion of at least part of the substrate in a bath of the tinting composition (step (203a)), this type of exposure step is generally known by the word “dip” or “dipping”.

Alternatively, the exposure step (203) can be done by spin-coating (step (203b))) the tinting composition on top of at least part of the substrate.

In all the examples the PC substrates are polycarbonates ophthalmic lenses of the kind known in the ophthalmic industry as semi-finished lenses, without any further surface treatment. The ophthalmic lenses were made by using polycarbonates such as homopolycarbonates and particularly homopolycarbonates of bisphenol −A and tetramethyl-3, 5-bisphenol-A. Some commercially available polycarbonates may be distributed by GENERAL ELECTRIC Co. under trade name of lexan®, by TEIJIN under trade name of PANLITE®, by BAYER under trade name BAYBLEND® or by DOW Chemicals under trade name of CALIBRE®.

The tinting performances of the tinting processes were evaluated with regard to luminous transmittance, the lower the transmittance after tinting, the more the dye has penetrated the substrate and with regard to haze value. In each of the examples below, unless stated otherwise, the tinting performances of transmittance and haze, were measured after the rinsing and curing steps of the process.

All experiments were done on two or three samples. In each case, the mean of the measured values is shown in a Table wherein “Sr. No” represents an internal reference of the different sample substrates, “Time” is the duration of exposure of the substrate to the tinting composition in minutes, “Temp” is the temperature of the tinting composition during the immersion step in Celcius degrees, “Trans” is the luminous transmittance in % and “Haze” is the haze in %.

Luminous transmittance (also called “relative light transmission factor in the visible spectrum”) Tv (or ζv) is defined in the standard ISO 13666:1998 and is measured according to the standard ISO 8980-3 (from 380 to 780 nm), using the same device.

The haze value of the final tinted substrates are measured by light transmission using the Haze-Guard Plus haze meter from BYK-Gardner (a color difference meter) according to the method of ASTM D1003-00, which is incorporated herein in its entirety by reference. All references to “haze” values in this application are by this standard. The instrument was first calibrated according to the manufacturer's instructions. Next, the sample was placed on the transmission light beam of the pre-calibrated meter and the haze value was recorded from three different specimen locations and averaged.

A reference un-tinted sample was also measured in term of transmittance and haze and the results are shown in table 0 below:

TABLE 0
un-tinted sample

| Sr. | Trans | Haze |
|---|---|---|
| No. | (%) | (%) |
| Ref | 89.3 | 0.14 |

### EXAMPLE 1

### Effect of the Carrier Compounds According to the Invention

Five ophthalmic lenses were tinted using a different variation of the general process chosen between five variations. Each process varies from the others principally by the carrier compound used in the tinting composition.

Further, the carrier compound concentration, the duration of the exposure step and the dye concentration were adjusted in order to attain roughly a class 3 tint as seen by the naked eye. A class 3 tint is commonly admitted to be a transmittance of 15% or less. This was necessary to obtain samples that enable a comparison of tinting performances: especially in term of haze comparison. The adjustment of those parameters was done through multiples experiments. Only the process enabling roughly at least a class 3 tint are shown in the table below.

Of the five processes, two were used to evaluate two references carrier compounds and three others to present the tinting performances of three carrier compounds according to the invention as shown in the Table 1 below.

The two reference carrier compounds are: 3,6-dithia-1,8-octane diol and bis 2-mercaptoethyl sulphide.

The three presented carriers according to the invention are 4,4′ thiodiphenol, 4-(methyl thio) benzyl alcohol, 4,4′ thio bisbenzenethiol.

The five substrates as disclosed above were immersed in each respective bath and followed the process described above.

After the process, the three substrates tinted using the tinting compositions of the invention are ophthalmic lenses according to the invention.

The measured tinting performances of the five processes applied each to a different one of the five ophthalmic lenses are given in Table 1 below. In Table 1, the label “Carrier” represents the concentration, in weight %, of the carrier compound and the label “Dye” represents the concentration, in weight %, of the dye compound.

It is to be noted that carrier compounds numbered 2 and 5 are the reference compounds.

TABLE 1
effect of carrier compound type on tinting performances:

| Sr. | Carrier | Carrier | Dye | Time | Temp | Trans | Haze | |
|---|---|---|---|---|---|---|---|---|
| No | Compound | (wt %) | (wt %) | (min) | (° C.) | (%) | (%) | Bath Odor |
| 1 | 4,4′ | 0.5 | 0.5 | 30 | 95 | 6 | 0.25 | No obvious smell |
| | thiodiphenol | | | | | | | |
| 2 | 3,6-dithia- | 0.5 | 0.5 | 60 | 95 | N/A | N/A | Not effective |
| | 1,8-octane | | | | | | | |
| | diol | | | | | | | |
| 3 | 4-(methyl | 0.2 | 0.5 | 40 | 95 | 15 | 0.3 | Smelly but Non |
| | thio) benzyl | | | | | | | Pungent |
| | alcohol | | | | | | | |
| 4 | 4,4′ thio bis | 0.5 | 0.75 | 15 | 95 | 4 | 2 | No obvious smell |
| | benzenethiol | | | | | | | |
| 5 | 2-mercapto- | 0.2 | 0.75 | 15 | 95 | 4 | 2 | Pungent |
| | ethyl Sulfide | | | | | | | |

The tinted lenses also show good stability in 5% and 10% sodium hydroxide solution.

Good quality tinting was obtained with less pungent baths for the carriers according to the invention: Sr. No 1, 3 and 4.

It was noted that the bath's smell disappeared most when the carrier compounds comprise two arylene groups: Sr. No 1 and 4.

It was also noted that the haze had a level compatible with the ophthalmic industry when X1 is an hydroxyl radical: Sr. No 1 and 3.

Last, it was noted, across all five compounds, that the tinting efficiency relative to the time of exposure (and concentration of carrier compound) is increased when AL1 is a mercapto radical: Sr. No 4 and 5, as compared to Sr. No 1 and 3.

Accordingly, depending on the needs and constrains bearing on the man skilled in the art, the most preferred carrier compounds may be ones with AL1 being mercpato radicals or ones with AL1 being hydroxyl radical and/or ones with two aryls.

For the ophthalmic industry, 4,4′ thiodiphenol, present in composition Sr. No 1, is the most preferred of the three carrier compounds presented above as the Haze performance is mandatory in this industry and the tinting composition is not smelly. It further has good performances in term of tinting efficiency relative to the time of exposure.

### EXAMPLE 2

### Effect of Duration of the Exposure Step on Tinting Performances

Four ophthalmic lenses were tinted using each one of four different variations of the general process. Each process varies from the others only by the duration of the immersion, ranging from 10 minutes to 40 minutes included, each process having a different immersion duration than the other processes.

Each tinting composition in this example comprises water as solvent and carrier compound 4,4′ thiodiphenol, used at 0.2% by weight.

The temperature during the immersion was equal to 95° C.

The tinting performances of the four processes applied each to a different one of the four ophthalmic lenses were then measured and presented in Table 2 below.

TABLE 2
effect of duration of the exposure step on tinting performances:

| Sr. | Time | Trans | Haze |
|---|---|---|---|
| No. | (min) | (%) | (%) |
| 2.1 | 10 | 34.3 | 0.4 |
| 2.2 | 20 | 15.9 | 0.27 |
| 2.3 | 30 | 8.97 | 0.25 |
| 2.4 | 40 | 3.4 | 0.3 |

It is shown that the transmittance reach class 3 after roughly 20 minutes immersion in the bath under 95° C. for a PC substrate using thiodiphenol at 0.2 wt % as carrier compound.

Good quality tinting was obtained, and the haze level of the ophthalmic lenses was acceptable. In particular, it was measured at all immersion duration that the haze did not exceed the limit found in the ophthalmic industry: 0.4%.

This examples show the ease with which the luminous transmittance of the ophthalmic lenses might be varied by adjusting tinting time.

### EXAMPLE 3

### Effect of Carrier Concentration on Tinting Performances

Four ophthalmic lenses were tinted using each one of four different variations of the general process. Each process varies from the others only by the concentration of carrier compound in the tinting composition, each process having a different carrier concentration than the other processes.

For each process, the immersion had a duration of thirty minutes, and the tinting compositions comprise water as solvent, 4,4′ thiodiphenol as carrier compound.

The temperature during the immersion was equal to 95° C.

The tinting performances of the four processes applied each to a different one of the four ophthalmic lenses were then measured. The measured values are presented in Table 3 below wherein “Carrier” represents the concentration in carrier compound in weight percentage.

TABLE 3
effect of carrier compound concentration on tinting performances:

| Sr. | Carrier | Trans | Haze | Time |
|---|---|---|---|---|
| No | (w %) | (%) | (%) | (min) |
| 3.1 | 0 | 89 | | 30 |
| 3.2 | 0.25 | 10.4 | 0.5 | 30 |
| 3.3 | 0.5 | 4.67 | 0.28 | 30 |
| 3.4 | 0.7 | 1.73 | 0.66 | 30 |

The transmission of the obtained ophthalmic lens may reach class 3 after a 30 minutes immersion in a bath under 95° C. with any carrier concentration greater than 0.25%. Good quality tinting was obtained.

Thus the tinting rate may be easily increased by increasing carrier concentration until a given concentration is reached. Indeed, it also shows that at higher carrier concentration there is a risk that the haze increases over ophthalmic acceptable limits (0.4% of haze).

This example shows the possibility of varying the luminous transmittance of the ophthalmic lenses by adjusting carrier concentration; or, conversely, reducing the needed tinting time by increasing carrier concentration.

1.-14. (canceled)

15. A tinting composition for tinting objects made of polymeric material comprising a dye, solvent and a carrier compound of the following formula:
[AL1-Sp2-Ar-Sp1]_{2-y}-X-Ak_{y}
wherein:
X is O or S;
Sp1 and Sp2 are independently a chemical bond and a spacer comprising a linear or branched (C1-C2) alkylene group;
Ar is one of a (C5-C12) arylene group and a (C5-C12) heteroarylene group;
AL1 is one of a —SH or a —OH radical or one of a —O—CH2-OH, —S—CH2-OH, —O—CH2-SH, —S—CH2-SH group;
Ak is a (C1-C6) alkyl group, linear or branched, with 0 to 2 non-consecutive non terminal carbons replaced by O or S; and
y is 0 or 1, and when y=0, the two AL1-Sp2-Ar-Sp1- branches can be identical or different.

16. The composition of claim 15, with y=0 and the two AL1-Sp2-Ar-Sp1- branches are identical.

17. The composition of claim 15, in which all Sp1, Sp2 and Ak, taken together do not contribute to the structure more than four atoms further defined as C, S, O.

18. The composition of claim 17, in which all Sp1, Sp2 and Ak, taken together do not contribute to the structure more than two atoms further defined as C, S, O.

19. The composition of claim 15, wherein at least one of Sp1, Sp2 is a chemical bond and not a spacer.

20. The composition of claim 15, wherein Ar is a phenylene or a toluylene group.

21. The composition of claim 15, wherein AL1 is a hydroxyl radical.

22. The composition of claim 15, wherein the carrier compound is a thiodiphenol compound.

23. The composition of claim 15, comprising 0.05% to 2% by weight carrier.

24. The composition of claim 23, comprising 0.2% to 1% by weight carrier.

25. The composition of claim 15, comprising 0.1 to 2% by weight dye.

26. The composition of claim 25, comprising 0.5% to 1% by weight dye.

27. The composition of claim 15, comprising 0.1% to 5% by weight surfactant.

28. The composition of claim 27, comprising 0.5%> to 2% by weight surfactant.

29. A tinting process for tinting a substrate made of polymeric material and comprising one or more main surfaces comprising:
(a) supplying a tinting composition according to claim 15; and
(b) exposing at least a part of one of the substrate's main surfaces to the tinting composition for a time sufficient to allow the effective tinting of the substrate.

30. The process of claim 29, wherein step (b) comprises immersion of at least part of the substrate into a bath of the tinting composition or spin-coating the tinting composition on at least part of the surface of the substrate.

31. The process of claim 29, wherein the polymeric material is an aromatic polycarbonate.

32. The process of claim 31, wherein the polymeric material is bisphenol A homopolycarbonate.

33. The process of claim 29, wherein the substrate is an ophthalmic lens.
